(19) United States
(12) Patent Application Publication
(10) Pub. No.: US 2011/0211698 A1
(43) Pub. Date: Sep. 1, 2011

(54) Encryption/Decryption System for a Mobile Device

(75) Inventors: Tien-Ji LI, Taichung City (TW); Cheng-Lung Li, Taichung City (TW)

(73) Assignee: GO Trust Technology Inc.

(21) Appl. No.: 13/035,739

(22) Filed: Feb. 25, 2011

(30) Foreign Application Priority Data
Mar. 1, 2010 (TW) 099105862

(51) Int. Cl. H04K 1/00

(52) U.S. Cl. 380/270

(57) ABSTRACT

An encryption/decryption system for a mobile phone configured to make a voice packet encryption/decryption during mobile communication. The mobile phone has a connecting device for an external plug-in device. The external plug-in device has a control unit, a security chip. When a security communication mode is activated, the communication between users can be prevented from being disclosed.

### BACKGROUND OF THE INVENTION

1. Field of the Invention

The present invention relates to an encryption/decryption system for a mobile phone. More particularly, the present invention relates to an encryption/decryption system for a mobile phone that is configured to make a voice packet encryption/decryption during mobile communication.

2. Descriptions of the Related Art

By the development of information industry, personal communication becomes more and more unsafe. According to recent articles, a Germany engineer announced that he has already cracked the encryption algorithm of mobile communication. The encryption technology is adapted for more than 21 years, and, among global 4.3 billion GSM mobile phones, eighty percent, i.e. 3.5 billion, GSM mobile phones use the security mechanism.

When GSM is adapted as a standard in 1988, a 64-bit encryption technology is adapted too, which is a simple technology referring to today's technology level. Although the GSM association upgrades the encryption technology to 128-bit system in 2007, most telecommunication proprietors do not upgrade immediate due to insufficient funds. Meanwhile, due to continuous society development, how to define preventing a secret from being disclosed today becomes a comprehensive issue, such as business secret protection, and also, the contents of secret becomes diversified.

### SUMMARY OF THE INVENTION

The primary objective of the present invention is to provide an encryption/decryption system for a mobile phone. By applying encryption and decryption, the communication between users can be prevented from being disclosed.

Another objective of the present invention is to provide an encryption/decryption system for a mobile phone. Telecom operators can use the present invention without upgrading instruments, and the users can apply the present invention in their mobile phone to achieve security communication.

The encryption/decryption system for a mobile phone being able to achieve the aforementioned objectives is described as follows, wherein the mobile phone has a connecting device for an external plug-in device being connected to the mobile phone, and the external plug-in device comprises:

a control unit, in which the control unit is connected to the connecting device of the mobile phone, and is configured to control a security chip;

the security chip, in which the security chip is configured to convert a digital code in to a digital encrypted package, wherein the digital code is transmitted to the security chip via the control unit, and the security chip then transmits the digital encrypted package to the mobile phone via the control unit, or, the security chip is configured to decrypt a digital encrypted package which is received via the control unit, and then transmit the decrypted digital code to the mobile phone via the control unit.

Therefore, by realizing the aforementioned devices, the external plug-in device is connected to the mobile phone via the connecting device. When the security communication mode is activated, the security chip of the external plug-in device generates key and processes key exchanging. Then the external plug-in device is configured to encrypt/decrypt voice data for transmitting data to the calling party/called party.

Further, the security chip comprises a key system being configured to generate key and process key exchange. The external plug-in device can also comprise a flash memory inside for a user to store data.

### BRIEF DESCRIPTION OF THE DRAWINGS

The drawings disclose an illustrative embodiment of the present invention which serves to exemplify the various advantages and objects hereof, and are as follows:

FIG. 1 shows a diagram of data exchange of the mobile phone of the present invention;

FIG. 2 shows a schematic diagram of the encryption/decryption system for a mobile phone of the present invention when speaking;

FIG. 3 shows a schematic diagram of the encryption/decryption system for a mobile phone of the present invention when receiving;

FIG. 4 shows a schematic diagram of the encryption/decryption system for a mobile phone of the present invention during a security communication;

FIG. 5 shows a system structure of a conventional mobile phone;

FIG. 6 shows a schematic diagram of the encryption/decryption system for a mobile phone of the present invention when encryption;

FIG. 7 shows a schematic diagram of the encryption/decryption system for a mobile phone of the present invention when decryption; and

FIG. 8 shows another embodiment of the encryption/decryption system for a mobile phone of the present invention.

### DESCRIPTION OF THE PREFERRED EMBODIMENT

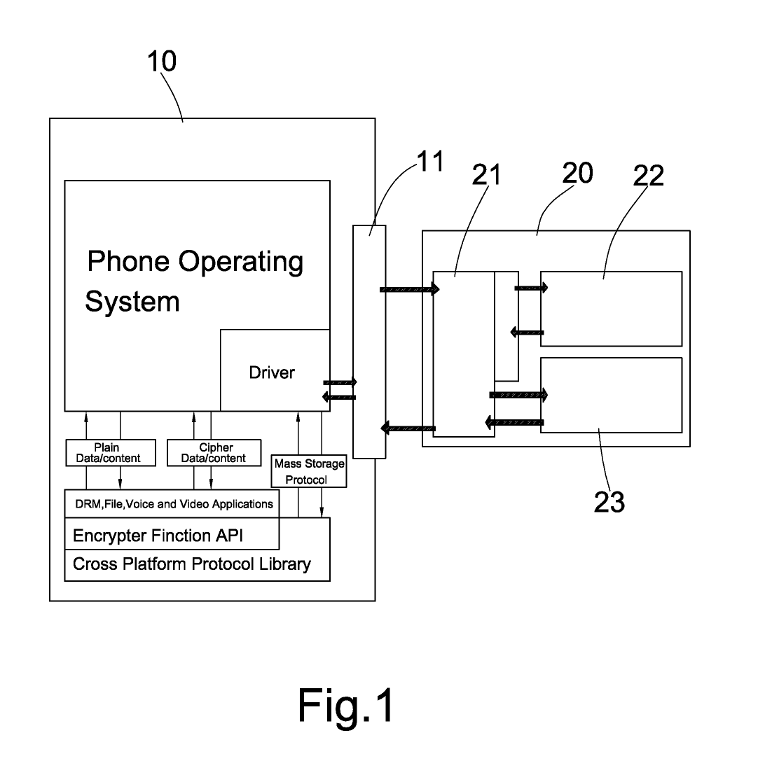

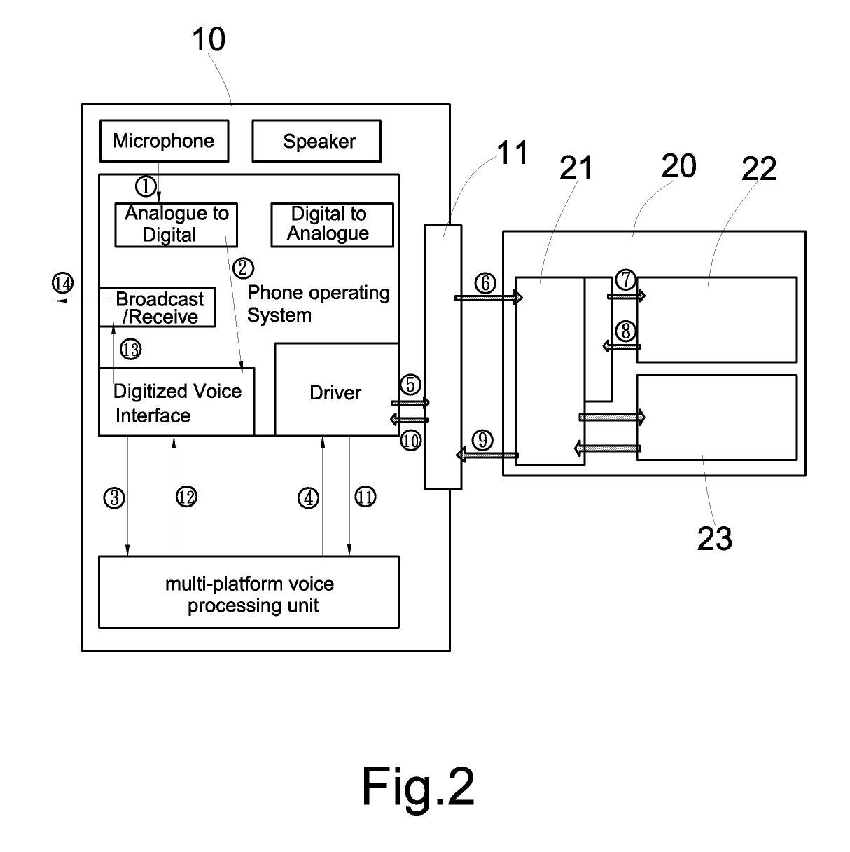

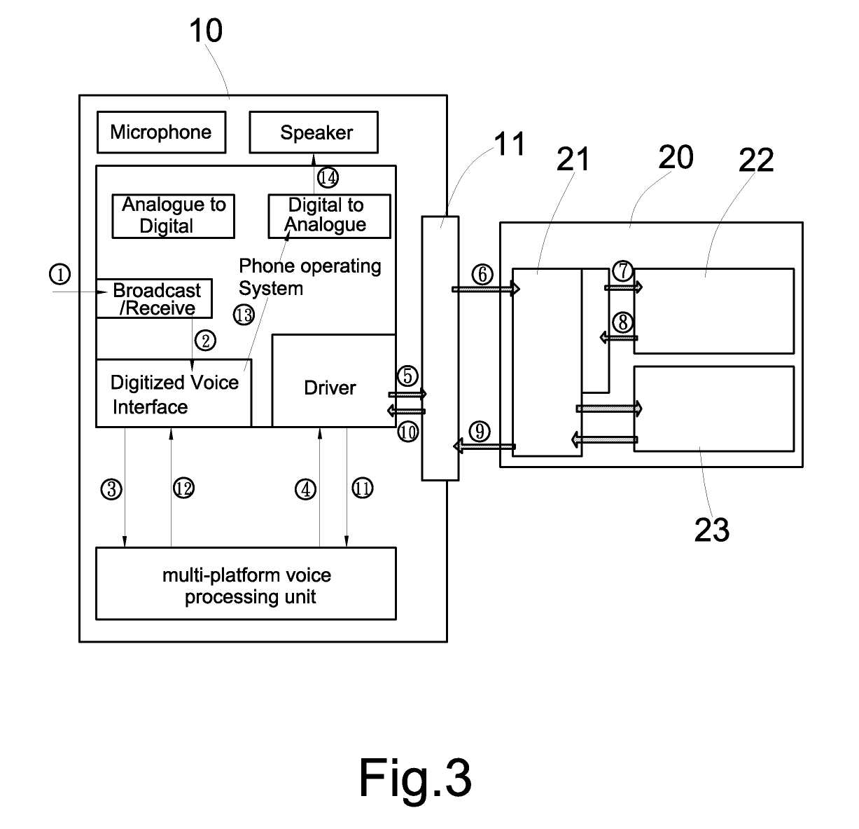

FIGS. 1-3 show an encryption/decryption system for a mobile phone of the present invention. The mobile phone 10 has a connecting device for an external plug-in device 20 being connected to the mobile phone 10, and the external plug-in device 20 comprises:

a control unit 21, in which the control unit 21 is connected to the connecting device of the mobile phone 10, and is configured to control a security chip 22;

the security chip 22, in which the security chip 22 is configured to convert a digital code in to a digital encrypted package, wherein the digital code is transmitted to the security chip 22 via the control unit 21, and the security chip 22 then transmits the digital encrypted package to the mobile phone 10 via the control unit 21, or, the security chip 22 is configured to decrypt a digital encrypted package which is received via the control unit 21, and then transmit the decrypted digital code to the mobile phone 10 via the control unit 21.

The security chip 22 comprises a key system for generating keys and keys exchange. The present invention can further comprise a flash memory 23 according to demands; therefore the control unit 21 can store digital data in the flash memory according to user operation.

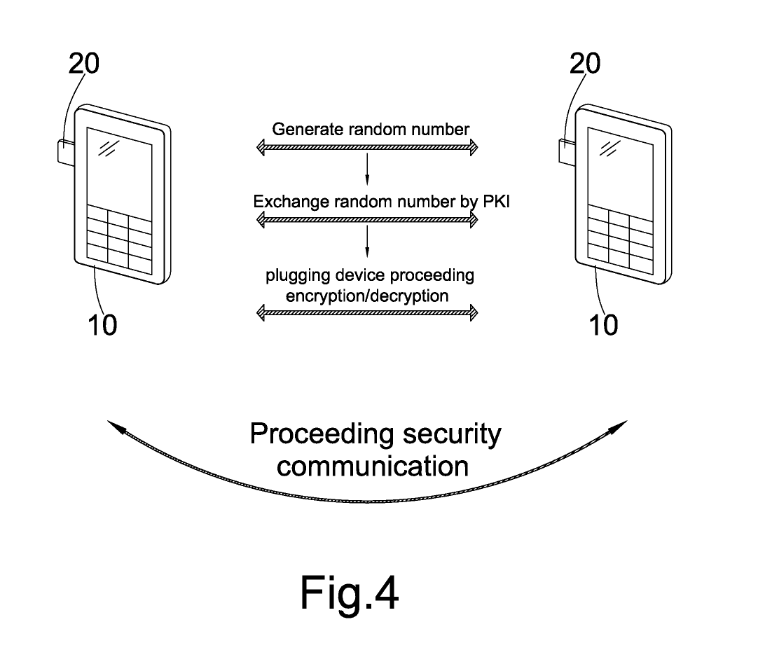

Refer to FIG. 4 as well as considering the aforementioned devices, when the users (calling party and called party) use the present invention, the external plug-in device 20 is connected to the mobile phone 10 via the connecting device 11. By activating a security communication mode, the security chip 22 of the external plug-in device 20 is configured to generate keys and proceed keys exchange, and then the external plug-in device 20 is configured to encrypt/decrypt voice data for transmitting the data to the calling party/called party.

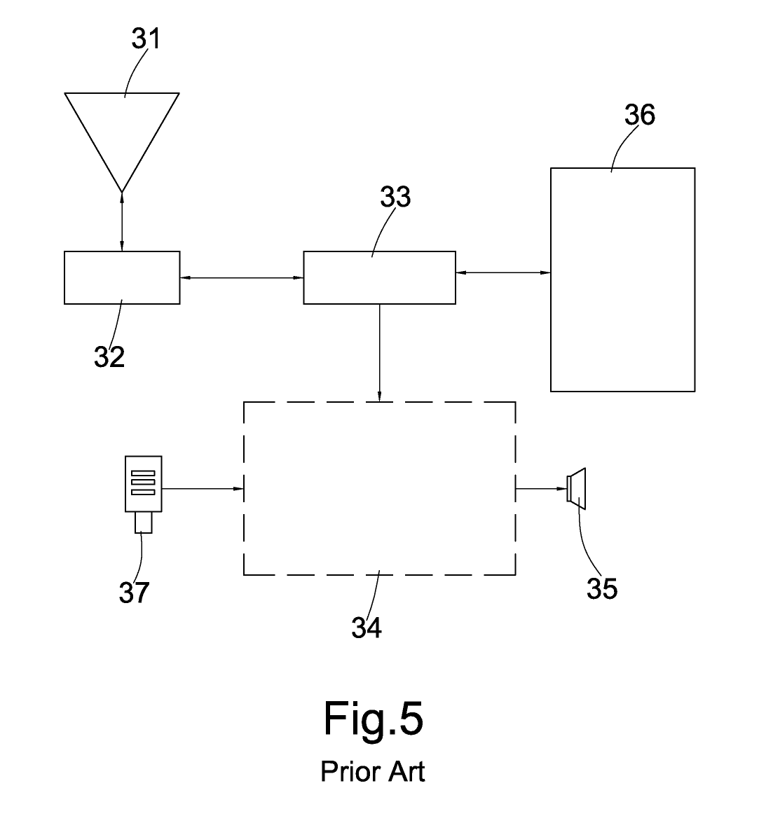

FIG. 5 shows a conventional mobile phone system structure. When the phone receives data, an antenna 31 transmits the received signal to a RF Called party/Transmitter module 32. The RF Called party/Transmitter module 32 proceeds the aforementioned signal by baseband signal processing 33, and then transmits the result to a voice processing unit 34 for decoding. Finally the voice is transmitted to the called party by a Multimedia speaker 35. The mobile phone 10 has a connecting device 11, and the user can freely select an accessory 36 for installing the external plug-in device on the mobile phone. During transmission, the calling party transmits the voice via the microphone 37 to the voice processing unit 34 for being coded, and then the signal is transmitted to the baseband signal process 33. Then the converted signal is transmitted to the RF Called party/Transmitter module 32 for being transmitted by the antenna 31.

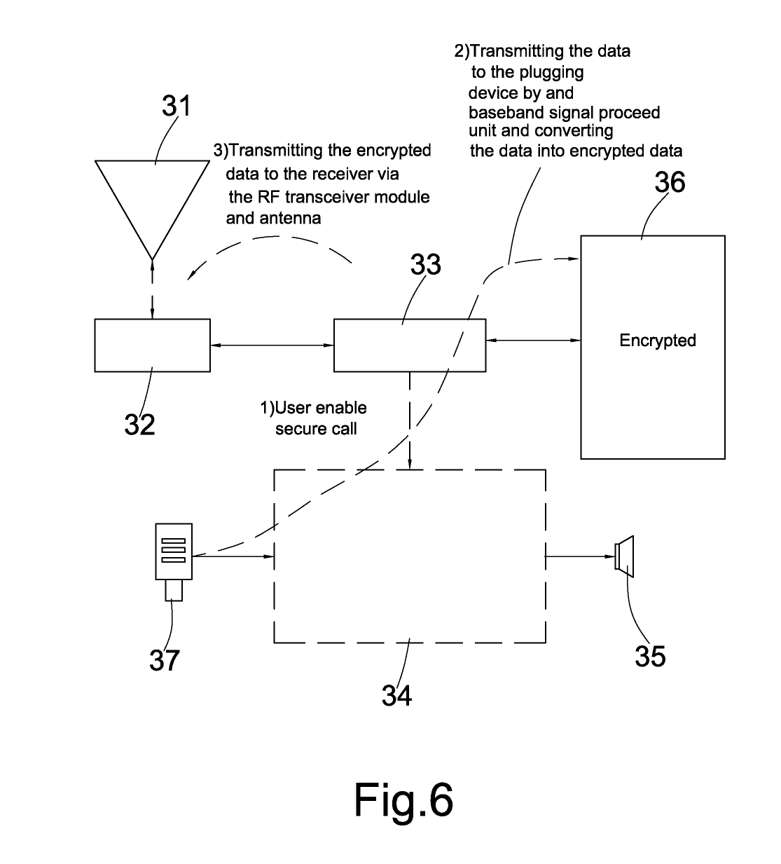

FIG. 6 shows an encryption flow of the encryption/decryption system for a mobile phone of the present invention. The calling party installs the external plug-in device 20 on the mobile phone 10 via the connecting device 11 of the accessories 36. When the calling party and the called party activate the security communication mode, the microphone 37 collects the calling party's voice and the voice processing unit 34 codes the voice data for being transmitted to the baseband signal processing 33. Then the coded information is transmitted to the external plug-in device 10, and the security chip 22 of the external plug-in device 10 then transmits the voice into a digital encrypted package. The digital encrypted package is then transmitted to the baseband signal processing 33 and transmitted to the RF Called party/Transmitter module 32 for being transmitted via the antenna 31.

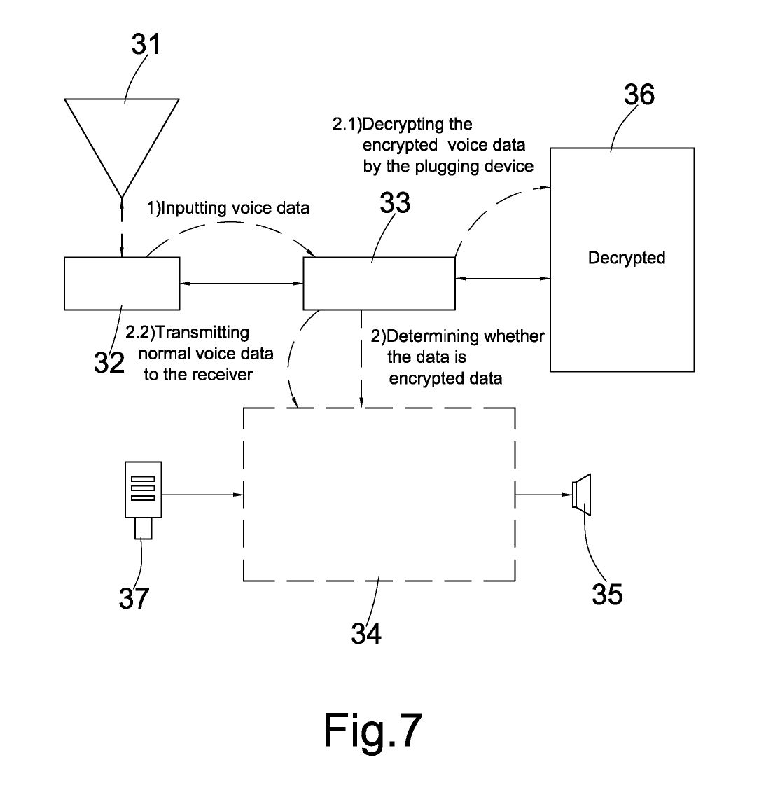

FIG. 7 shows a decryption flow of the encryption/decryption system for a mobile phone of the present invention. The called party installs the external plug-in device 20 on the mobile phone 10 via the connecting device of the accessories 69. When the antenna 31 receives signal and transmits the signal to the RF transceiver 32, the baseband signal processing 33 is configured to determine whether the phone call is a security encrypted phone call. Once the phone call is not a security encrypted phone call, the received signal is then decoded by the voice processing unit 34 and the Multimedia speaker 35 plays the voice to the called party. Once the phone call is ensured to be a security encrypted phone call, the baseband signal processing 33 then transmits the digital encrypted package to the external plug-in device 20 for decryption. Then the decrypted coding information is transmitted to the voice processing unit 34 for being decoded and the Multimedia speaker 35 plays the voice to the called party. By the aforementioned embodiment, the security communication between the calling party and the called party is ensured.

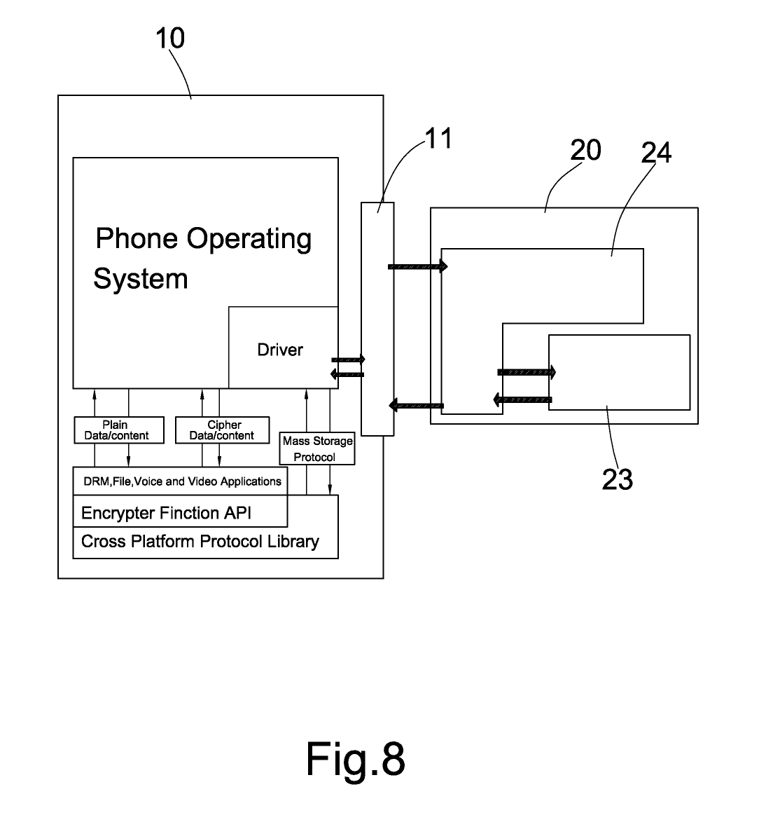

FIG. 8 shows another embodiment of the encryption/decryption system for a mobile phone. To save space and well arranging wires, the control unit 21 and the security chip 22 can be integrated as a multi-function chip 24. Therefore the aforementioned effects are also ensured as well as the space is saved and the manufacturing cost and malfunction rate are reduced.

Comparing with the conventional technologies, the present invention has advantages as follows.

1. The user can achieve security communication without waiting the Telecom operators to upgrade instruments.

2. The present invention is easy to operate. The user only needs to install the external plug-in device on the mobile phone and follow simple operation steps without additional training

3. The present invention can be applied widely for the mobile phones with connecting device in the market.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An encryption/decryption system for a mobile phone, wherein the mobile phone has a connecting device for a external plug-in device being connected to the mobile phone, and the external plug-in device comprises:
a control unit, in which the control unit is connected to the connecting device of the mobile phone, and is configured to control a security chip;
the security chip, in which the security chip is configured to convert a digital code in to a digital encrypted package, wherein the digital code is transmitted to the security chip via the control unit, and the security chip then transmits the digital encrypted package to the mobile phone via the control unit, or, the security chip is configured to decrypt a digital encrypted package which is received via the control unit, and then transmit the decrypted digital code to the mobile phone via the control unit.

2. The encryption/decryption system for a mobile phone as claimed in claim 1, wherein the external plug-in device further comprises a flash memory for a user to store data.

3. The encryption/decryption system for a mobile phone as claimed in claim 1, wherein the communication password is written according to a data program.

4. The encryption/decryption system for a mobile phone as claimed in claim 1, wherein the control unit is configured to be connected to the security chip via a security chip socket.

5. The encryption/decryption system for a mobile phone as claimed in claim 1, wherein the security chip further comprises a key system being configured for exchanging keys during communication.

6. The encryption/decryption system for a mobile phone as claimed in claim 1, wherein the control unit is further configured to be integrated with the security chip as a multi-function chip.
